(19) United States
(12) Patent Application Publication
(10) Pub. No.: US 2006/0115691 A1
(43) Pub. Date: Jun. 1, 2006

(54) Method for exhaust gas treatment in a solid oxide fuel cell power plant

(75) Inventors: Anne-Mette Hilmen, Bjornemyr (NO); Rord Peter Ursin, Rykkinn (NO)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Aker Kvaemer Engineering & Technology, Lysaker (NO); Statkraft Development AS, Oslo (NO)

(21) Appl. No.: 10/538,167

(22) PCT Filed: Dec. 10, 2003
(86) PCT No.: PCT/NO03/00413

§ 371 Date: Jun. 8, 2005

(30) Foreign Application Priority Data
Dec. 10, 2002 (NO) 20025925

(51) Int. Cl. H01M 8/12; H01M 8/04; H01M 2/08

(52) U.S. Cl. 429/13; 429/35; 429/32; 429/26

(57) ABSTRACT

The invention relates to anode exhaust gas treatment methods for solid oxide fuel cell power plants with CO2 capture, in which the unreacted fuel in the anode exhaust (301) is recovered and recycled, while the resulting exhaust stream (303) consists of highly concentrated CO2. It is essential to the invention that the anode fuel gas (102) and the cathode air (205) are kept separate throughout the solid oxide fuel cell stacks (1). A gas turbine (202,207) is included on the air side in order to maximise the electrical efficiency.

### BACKGROUND

1. Field of the Invention

The invention relates to methods for anode exhaust treatment in solid oxide fuel cell power plants where the air stream and fuel stream is kept separate throughout the system. Particularly, the invention relates to solutions for recovering and recycling the unspent fuel from the anode fuel exhaust gas.

2. Background Information

An increasing demand for electric power combined with increasing environmental awareness has initiated extensive research for developing cost effective and environmentally friendly power generation. Although several renewable power sources are available, only nuclear and hydrocarbon fuelled power plants can supply the bulk of the power being demanded. Nuclear power plants suffer from safety risks and problematic radioactive waste disposal. Future development of nuclear power plants seems very limited, mostly due to lack of political acceptance. Thus, power plants based on fossil fuels are called upon to fill most of the energy gap. However, a continuous development of scientific data on the Greenhouse effect and political agreements such as the Kyoto protocol from 1997, is generating an increasing push towards limiting and reducing greenhouse gas emissions. As a result of this trend, several countries seek to limit their carbon dioxide (CO₂) emissions and establish annual maximum emission levels. In this endeavour, CO₂ emissions from fossil fuel power plants is a main concern since such plants are a considerable source of CO₂ emissions. As an example, about one third of the US CO₂ emissions come from such power plants. Typically, the CO₂ emissions from a natural gas based power plant producing 3 TWh per year would be in the order of 1.1 million tons per year [ref. Gassm.]. It is therefore desired to develop efficient fossil fuel power plants with capture of CO₂ that subsequently can be sequestered. Sequestration of the CO₂, produced from a large-scale power plant, will most likely be achieved by injection as gas, liquid or hydrates into subterranean formations or into deep seawater. A commercial value for the produced CO₂ may be obtained when used for enhanced oil recovery in producing oil fields.

Several processes/concepts for power production from fossil fuels with greatly reduced CO₂ emissions are known in the art. These processes produce concentrated and pressurised CO₂ suitable for sequestration or industrial usage. The methods for recovering the CO₂ from natural gas based power production may be divided into three main categories, i.e.:

1) Pre-combustion decarbonisation

2) Oxyfuel or oxygen-fired combustion
3) Post-combustion CO₂-capture

Precombustion involves a “decarbonisation” of the fuel prior to usage in a standard Gas Turbine Combined Cycle power plant (GTCC) plant or alternative power producing technology based on fossil fuels. As a typical example, such a process would include reformation, water gas shift, and CO₂ removal by chemical absorption using conventional amine systems. The resulting fuel gas is hydrogen-rich and may be used in some gas turbines. An advantage of this concept is that it is essentially based on a series of known unit operations. There is however only a small number of gas turbines available that may use the hydrogen rich gas as fuel. Therefore, unless modifications/qualifications of other gas turbines are made, this concept will not be available at different scales. The most economical scales for the components are large and the specific costs and efficiencies will suffer as the scale is reduced. Another disadvantage of applying conventional CO₂ removal solutions in precombustion is that they are operated at low temperature, requiring cooling and reheating of the gas due to the CO₂ removal. This concept will have an efficiency that is lower than for a standard GTCC plant or other alternative technology. The precombustion are typically considered combined with other less developed power producing technologies such as fuel cells. Also, other emerging CO₂ removal technologies are typically considered in the literature such as CO₂ selective membranes, hybrid sorbent/membrane systems, physical or chemical sorbents.

The Oxyfuel category includes concepts supplying the oxygen used to oxidise the natural gas in such a manner that nitrogen does not enter the reaction zone. The combustion products are, in principle, only CO₂ and H₂O. The water is removed by cooling/condensation of the combustion products and the result is a nearly pure CO₂ gas stream. One way of keeping nitrogen away from the reaction zone is to produce oxygen in a conventional cryogenic air separation unit prior to combustion. Other variations include usage of high temperature ceramic oxygen transfer membranes to produce oxygen or supply of oxygen by means of a metallic oxygen carrier (chemical looping combustion). One example of a oxyfuel concept is a process based on oxygen production in a conventional air separation unit(s) (ASU), combustion in a specialised gas turbine, utilisation of heat in a steam bottoming cycle and recycle of gas turbine exhaust (CO₂/H₂O) for temperature control. For plant sizes below app. 200 MW, the cryogenic air separation units must be sized down from the optimum scale. This gives a considerable cost penalty in the 10-50 MW scale. Further, a smaller scale gas turbine with higher specific cost and lower performance must be assumed. Also the use of CO₂/H₂O recycle to control the temperature will consume energy at the expense of total efficiency. Both investment cost and energy consumption are very high for generation of oxygen at the purity and quantity required in Oxyfuel cycles. Most of the prior art has required the use of a source of highly concentrated oxygen, ref. U.S. Pat. No. 5,724,805, U.S. Pat. No. 5,956,937 and U.S. Pat. No. 5,247,791. In order to reduce the cost of oxygen, it is a goal to include the use of oxygen selective ion transport membranes in Oxyfuel cycles. This implies that a way to achieve a positive oxygen partial pressure differential and the required temperature, must be found. A conventional heat recovery system is proposed to utilize the heat emitted by the cycle. These are costly, and more economical ways for the utilization of this heat energy are demanded.

Postcombustion is based on cleaning of the exhaust from a GTCC plant or other power producing technology based on fossil fuels. The exhaust stream typically contains roughly 3-4 vol % CO₂ that may be removed from the exhaust in a wet scrubbing process involving chemical absorption using an amine based absorbent. Heat (steam from the power plant) is required to disassociate the CO₂ from the absorbent. The result is an almost 100% pure CO₂ gas at atmospheric pressure that can be pressurised for transport and disposal. This technology can be retrofitted to existing plants and also it may be “turned off” without stopping the power production from the plant. However, the low concentration of CO₂ requires large gas handling systems and the treated exhaust gas will still contain approximately 15% of the CO₂, also NOₓ and some amines will be present in the exhaust gas. The efficiency will be lower than for a standard GTCC plant or alternative technologies due to the energy needed to separate the CO₂. Alternative less developed CO₂ separation technologies that typically would be considered are chemical or physical sorbents or CO₂ selective membranes.

The technologies described above will typically have electrical efficiencies less than 50%. In addition, many of them will still emit about 10-15% of the CO₂. It is therefore a desire to develop fossil fuel driven power plants with CO₂ capture that is highly efficient, emits less CO₂ and has a lower cost of energy than prior art technology.

Two separation technologies not mentioned in the description above are of particular interest for present invention, i.e. hydrogen selective membranes and cryogenic CO₂ separation.

Various types of hydrogen selective membranes are generally known. Hydrogen separation membranes can typically be categorized into two main types:

Microporous types, which comprise polymeric membranes and porous inorganic membranes

Dense types, which comprise self-supporting non-porous metal, non-porous metal supported on a porous substrate such as porous metal or ceramic, and mixed ionic and electronic conduction materials.

The microporous type of membranes generally has a limited selectivity, while the dense type has “infinite” selectivity.

Polymeric membranes typically cannot be used at operating temperatures above 250° C. due to lack of stability and they also are incompatible with many chemicals that can be present in the feed stream. The polymeric membranes also suffer from a lack of selectivity of hydrogen over other gases and the product gas therefore is relatively impure.

Micro porous inorganic membranes are typically made of silica, alumina, titania, molecular sieve carbon, glass or zeolite. All are fabricated with a narrow pore size distribution and exhibits high hydrogen permeability but relatively low selectivity due to the relatively large mean pore diameter. Typical operating temperature for a silica membrane would be <300˜400° C.

Dense membranes normally consist of palladium or palladium alloys or mixed ionic and electronic conducting materials. The Pd and Pd-alloy based membranes typically consist of a thin non-porous or dense film or foil of Pd or Pd-alloys coated on a porous support of ceramics or porous stainless steel. The thickness of the Pd or Pd alloys film is at present typically 70 to 100 μm for commercial membranes (small scale) and due to the high price of Pd this makes these membranes very expensive and the thickness also results in low permeance. It is essential to have very thin Pd or Pd-alloy films/foils to get a high permeance and an acceptable price. Supported Pd or Pd-alloy membranes of much thinner film thickness are often reported in the literature. Typical operating temperatures for Pd and Pd-alloys membranes are in the range 200-500° C. and even higher temperatures have been stated (up to 870° C.).

Mixed ionic and electronic conducting (MIEC) membranes have mostly been studied for oxygen separation as described earlier. MIEC membranes for hydrogen separation is far less developed, also compared to Pd-alloy membranes and microporous membranes. These membranes are however expected to develop fast due to the large efforts in developing similar oxygen separating MIEC membranes. The MIEC hydrogen separating membranes function by transferring hydrogen as protons and electrons through the dense mixed ceramic material. Typical operating temperatures for the mixed ionic and electronic conducting membranes is 600-1000° C.

Cryogenic technology, cooling to temperatures between −40 and −55° C., for separating CO₂ from a gas stream is conventional technology and very well known. This technology is also used for cooling and liquefaction of CO₂. The separation is performed at elevated pressure in order to avoid solid CO₂ and to increase the required operating temperature. The feed gas to be separated is compressed and dehydrated (to avoid ice) and cooled. After cooling most of the CO₂ is liquefied and the mixture can easily be separated. Separation can be performed by a simple gravity-based separator or a column could be used in order to obtain a purer CO₂ or less CO₂ in the cleaned gas.

In recent years many solid oxide fuel cell based power plant concepts of substantial size (above 1 MW) have been presented [ref]. These studies are often based on operation at pressure, typically 3-15 bars. This increases the electrical efficiency and also makes hybrid systems including gas turbines attractive. Typically, the air is compressed and preheated before entering the SOFC, where electrical power is produced in electrochemical reactions with the fuel and the generated heat is partly absorbed by the air stream. Subsequently, the hot oxygen depleted air is typically mixed with the spent fuel leaving the anode side and the mixture is combusted to further increase the gas temperature before the heated gas is expanded in a turbine producing additional electricity. The pressurised solid oxide fuel cell/gas turbine hybrid systems appears to be very attractive for power production due to the high electrical efficiency that can be expected for these systems, typically more than 70% (in the multi-MW range). Examples of typical pressurised solid oxide fuel cell/gas turbine hybrid concepts that are described in literature can be found in the following references [1, 2, 3, 4, 5]. These systems does however all emit the combusted fossil fuel as CO₂ to the atmosphere.

For these typical solutions both precombustion decarbonisation and postcombustion CO₂ capture methods can be applied in order to make the concept “zero emission”, but this will be at the expense of efficiency loss and increased cost as for the other solutions presented.

However, a solid oxide fuel cell system can be classified as an oxyfuel system since the oxygen is transferred through the fuel cell wall to the anode side, leaving the nitrogen on the cathode side, provided that the air stream and the fuel stream is kept separated after the electrochemical reaction.

A so-called zero emission solid oxide fuel cell power pilot plant of this type is developed by Shell together with Siemens Westinghouse Power Corporation. The goal is to use fossil fuels for power generation with high efficiency and without emission of CO₂ to the atmosphere. The pilot plant will be operated at atmospheric pressure and will be located at Kollsnes in Norway.

There are two major differences to the zero emission solid oxide fuel cell power plant concept compared to those described above. 1) A seal is applied keeping the cathode air stream separated from the anode fuel gas in such a manner that the two streams are not mixed after the fuel cell reactions. 2) An afterburner is applied in order to further utilise the unreacted fuel leaving the anode side of the fuel cell. Two types of afterburners has been suggested: 1) An additional SOFC unit operated to convert the majority of the remaining fuel and producing some additional electricity, and 2) using an oxygen transport membrane (OTM) to provide the oxygen for combusting the remaining fuel. The heat released can be used to generate steam for use in a steam turbine. Both he SOFC afterburner and an OTM will be very expensive solutions and give limited additional electricity output.

Prior art describes recycle of anode gas in fuel cell systems, ref. U.S. Pat. No. 5,079,103. The described systems use pressure swing adsorption (PSA) for separation of CO₂ from H₂ and CO in the anode exhaust from a SOFC stack. The PSA system operates by adsorption of CO₂ from the anode exhaust. However, the CO₂ content in this stream is substantial and the required PSA system will increase the overall cost and complexity.

It is thus desired to find simple and preferably cheap solutions for utilising the remaining unreacted fuel in the anode exhaust gas for additional power production maintaining a high electrical efficiency and simultaneously produce clean and preferably pressurised CO₂ stream.

### BRIEF DESCRIPTION OF THE INVENTION

The subject invention presents a method for solving the problems described above. The present invention relates to solid oxide fuel cell systems having a seal system that keeps the air and fuel stream separated. Particularly, it relates to the fuel cell anode side exhaust gas treatment in such a system, and more particularly, to exhaust gas treatment methods that separate and recycle the unspent fuel to the main SOFC. The invention is most suitable for SOFC systems that operate at elevated pressures and are integrated with a gas turbine.

The air is compressed and preheated before it enters the fuel cell stack at the cathode side. Fossil fuel, preferably natural gas, is pretreated to remove poisons such as sulphur compounds before it is converted by steam reforming to a mixture of H₂, CO, CO₂ and H₂O. This mixture enters the fuel cells at the anode side. Oxygen in the air is transferred through the fuel cell wall and reacts electrochemically with H₂ and CO, generating electricity and heat. The cathode and anode gas is kept separate by a seal system.

The oxygen depleted air on the cathode side absorbs heat as it passes through the fuel cell on the cathode side. The hot oxygen depleted air is subsequently expanded in a turbine producing additional electricity, heat exchanged with the incoming air and vented.

The anode exhaust can preferably partly be recirculated to the reformers in order to provide the steam required for the steam reforming (otherwise steam must be supplied to the reformers). The remaining fraction of the anode exhaust gas is further treated in two optional ways: 1) in a hydrogen membrane unit and 2) in a cryogenic separation unit.

Using option 1), a high temperature hydrogen membrane unit, the hydrogen in the exhaust gas is transferred through the membrane by a partial pressure difference and as hydrogen is removed from the feed gas side, the water-gas-shift reaction converts more of the remaining CO to hydrogen (the membrane must catalyse water-gas-shift reaction or a catalyst has to be included). A sweep gas such as steam may be applied on the permeate side to increase the driving force. The anode exhaust gas consists mostly of CO₂ and H₂O after the membrane separation (some H₂ and CO and also N₂ will be present). The water is easily removed and the result is a concentrated CO₂ stream at roughly the operating pressure. The permeate hydrogen rich gas is compressed and recirculated to the fuel cell or reformer, where it is efficiently utilised to generate electricity.

Using option 2), the cryogenic method the anode exhaust gas is cooled, water is removed before the gas is compressed, cooled, further dried and CO₂ is separated by a gravity-based separator or a column at moderately low temperatures. The resulting gas contains mainly hydrogen, CO some N₂ and an amount of CO₂ that depends on the separation temperature. The resulting liquid stream is pressurised CO₂ and can be transported by ships or trucks if desired.

Both of these options are advantageous alternatives to pressure swing adsorption for pressurised SOFC systems. By usage of hydrogen selective membranes, hydrogen is recovered from the fuel cell anode exhaust. The fuel stack should in this case be pressurised in order to obtain as great driving pressure as possible over the hydrogen selective membranes. The membranes may operate at elevated temperature and the amount of hydrogen that has to be removed is relatively small compared to the amount of CO₂ in the anode exhaust. Additionally, the CO₂ may pass the membranes on the retentive side without large pressure drops. The resulting system is simple and has a very good potential for cost savings. This will in particular apply if the CO₂ is to be captured and exported from the power plant by pipeline. In this case some hydrogen is permitted in the retentive gas, allowing a non-perfect hydrogen split and selection of a small hydrogen membrane area. These factors enable hydrogen selective membranes, which now rarely is used, to be competitive when used in a pressurised fuel cell system with CO₂ capture.

Another advantageous option is usage of a cryogenic, gravity based separation process. The overall system will then include a combination of a high temperature SOFC system with a low temperature cryogenic separation process. A detailed investigation focused on the required purity of the recovered hydrogen and CO will reveal that a substantial amount of diluents are permissible. This enables a relatively simple cryogenic separation process. This option may easily produce liquefied CO₂ ready for transportation by trucks or ships and is therefore particularly beneficial if CO₂ is to be captured and exported and the SOFC stack is pressurised.

An important advantage of potentially cheap and efficient separation/recycle processes, is that it will be possible to reduce the fuel utilisation in the main SOFC stack. Reduction of the fuel utilisation will increase the voltage and hence increase the SOFC efficiency further. Zero emission solid oxide fuel cell power plants based on the concepts of the present invention hold the promise of high efficiency power production from fossil fuels with CO₂ capture, much higher efficiency than can be expected for other typical power production systems with CO₂ capture. Another important advantage of the zero emission SOFC/gas turbine hybrid solution is the applicability also in the much lower MW range than would be preferred for many of the other CO₂ capturing solutions presented above.

The membranes of interest for the present invention are the high temperature hydrogen selective membranes.

Particularly, hydrogen selective membranes including water-gas-shift activity are of interest. The major difference of the employment of H₂ selective membranes in the present invention compared to other application is that it is used as an exhaust gas treatment method to recover unspent fuel. The embodiment of the present invention does not require a very pure hydrogen stream since CO is also a reactant for SOFC. Also, a certain amount of CO₂ can be tolerated (trade-off with larger gas volumes). The present embodiment also allows for the use of a sweep gas, preferably steam, at the permeate side. There will also be relatively small amounts of hydrogen that are going to be recovered and this reduces the required membrane area needed. Another advantage of the present application is that it leaves the CO₂ at high pressure while the hydrogen permeate gas looses pressure. The hydrogen stream flow rate is considerably smaller than the CO₂ stream, thus much less compression cost is required to compress the hydrogen compared to what would be needed for the CO₂.

The combination of the cryogenic separation with the zero emission SOFC system provides a simple and elegant means of separating and recycling the unspent fuel. It is relatively cheap and consumes little additional energy.

Thereby, the subject invention presents methods that simplifies the anode gas treatment in SOFC cycles with CO₂ capture.

### BRIEF FIGURE DESCRIPTION

FIG. 1 is a schematic of the main principles of the present invention.

FIG. 2 is a schematic flow diagram of the present invention showing the main parts of the power plant.

FIG. 3 is a schematic flow diagram of a specific embodiment of the present invention using a cryogenic separation process in a power plant.

FIG. 4 is a schematic flow diagram of a specific embodiment of the present invention using a separation process based on high temperature hydrogen selective membranes in a power plant.

FIG. 5 is a schematic flow diagram of a specific embodiment of the present invention using a separation process based on high temperature hydrogen selective membranes in a power plant, in which the recovered hydrogen is combusted to increase the temperature of the oxygen depleted air.

The invention also allows production of heat and/or steam usable for distribution to district heating or nearby steam consumers.

### DETAILED DESCRIPTION

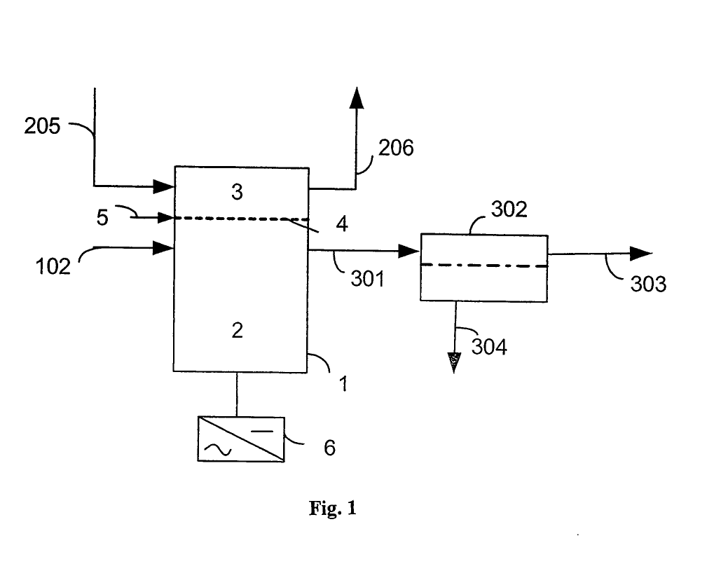

Referring now in detail to the figures of the drawings, in which identical parts have identical reference symbols, and first, particularly, to FIG. 1. FIG. 1. shows the main principles of the present invention. The main SOFC stack 1, is divided into an anode section 2 and a cathode section 3 by a sealing system 4. This seal system may be a steam seal. Addition of steam, 5, is needed for this particular seal. In order to simplify the schematic, the anode section comprise of all needed reforming steps, as well as optional internal recycle of part of the anode exhaust to the reformers to provide steam required for the steam reforming, or steam addition to the reformers if internal recycle of fuel is omitted, in addition to the fuel cells anode side. No details of the fuel cells are shown. In the present example the fuel cells are of the tubular (one closed end) solid oxide type. Poison-free fuel containing the element carbon 102, typically natural gas, is fed to the anode side 2, and compressed and preheated air 205 is fed to the cathode side 3 of the main SOFC stack 1. The reformed fuel is electrochemically reacted with oxygen from the air on the anode side 2 of the fuel cell producing electricity and heat. The electricity is typically converted from DC to AC in an inverter 6 The anode exhaust gas 301, typically consisting of H₂, CO, CO₂ and H₂O is further transferred to the separation process 302 where the main aim is to separate the CO₂ and H₂O from the unspent fuel. The recovered fuel 304 is typically recirculated to the main fuel cell stack.

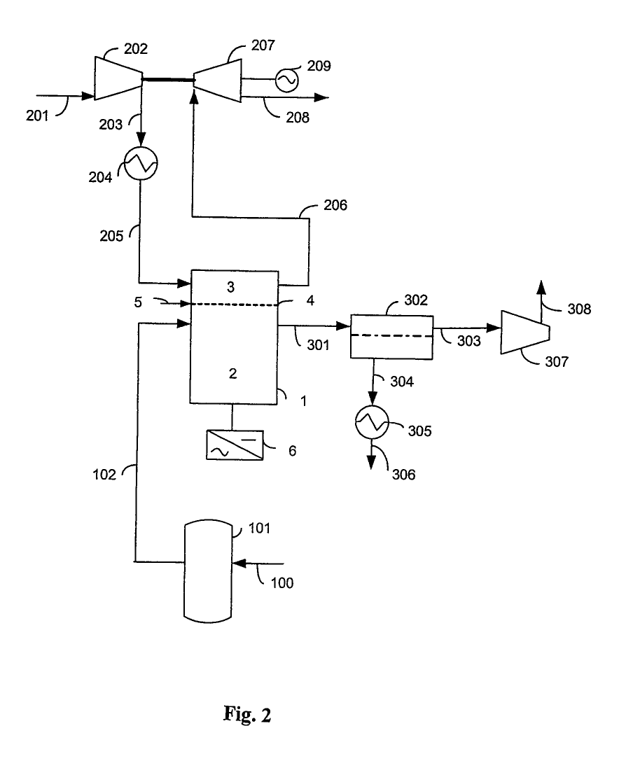

FIG. 2 is a schematic flow diagram of the present invention showing the main parts of the power plant. A line containing fuel 100, typically natural gas, is shown going to a fuel pretreatment unit 101. This fuel pretreament unit contains all necessary poison removal steps to produce a fuel that is sufficiently clean to enter the reformer and fuel cells in the main SOFC unit 1 through line 102. Typically, the pretreatment unit would consist of desulphurisation by one of the conventional methods known to those skilled in the art. The cleaned fuel enters the main SOFC stack and is converted as described for FIG. 1, producing electricity and heat. The anode exhaust gas is transferred through line 301 to the separation process 302 as described for FIG. 1. The concentrated CO₂ stream 303 leaving the separation process is typically further compressed in a conventional compression train 307 before it is sent to sequestration 308. The recovered fuel 304 is typically cooled 305 before it typically is recycled to the main SOFC. The air stream 201 is compressed to the desired operating pressure in a compressor 202, typically the compressor part of a gas turbine. The compressed air 203 is preheated in a heater 204 before it enters the cathode side 3 of the main SOFC. The air flowing through the cathode side of the fuel cell absorbs heat and is vitiated in oxygen. The heated and oxygen depleted-air leaving the main SOFC 206 is expanded in a turbine 207 producing additional energy.

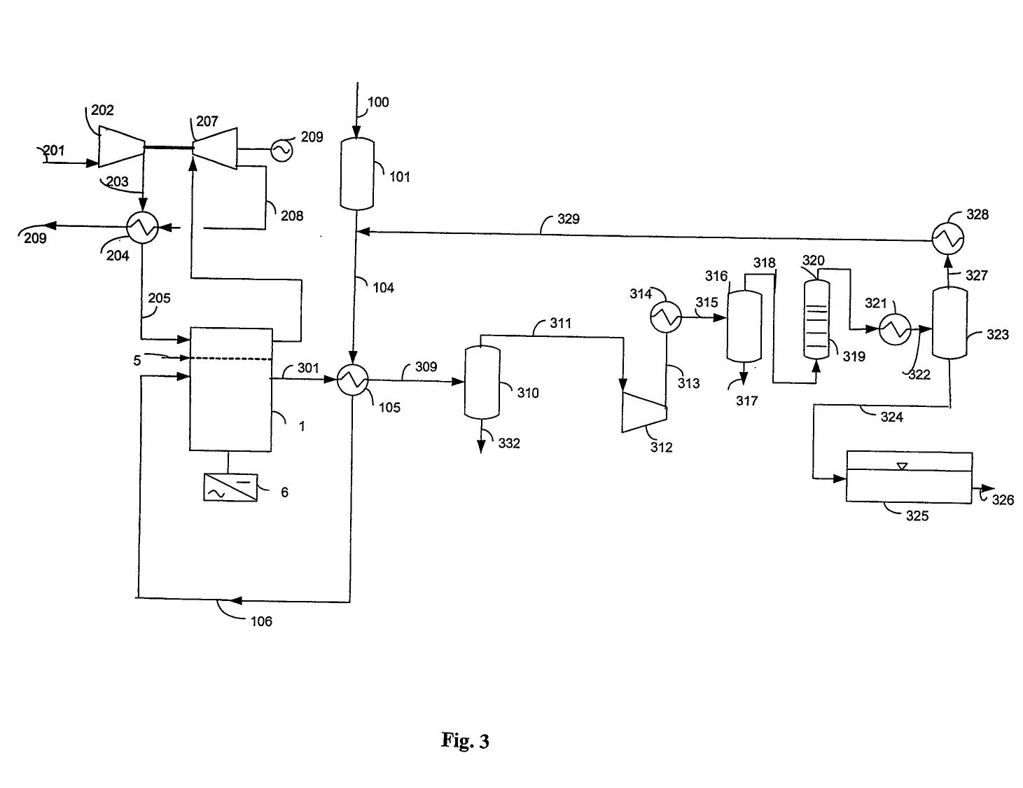

FIG. 3 is a schematic flow diagram of a specific embodiment of the present invention using a cryogenic separation process in a power plant. The fuel pretreatment 101, main SOFC 1 and gas turbine 201-209 units have already been described above. The expanded air 208 is typically heat exchanged with the incoming air 203 in a recuperator 204 before it is vented 209. In the present example, the fuel 100, typically natural gas, enters the fuel pretreatment unit 101 at 8.5 bara and 20° C. and is desulphurised by passing through a fixed-bed absorbent system. After desulphurisation, the gas 103 is mixed with the recycle gas 329 from the separation process. The mixture 104 is heat exchanged 105 with the anode exhaust gas 301 to increase the temperature to about 200° C. The preheated gas 106 enters the main SOFC 1 and is converted in several steps as described previously. The anode exhaust gas leaves the main SOFC stack at a temperature of about 800° C. The anode exhaust gas typically consist of 3.0% H₂, 1.6% CO, 33.7% CO₂, 60.0% H₂O and 1.8% N₂. After heat exchange in 105, the water is removed in a condenser or scrubber 310. Additional coolers not shown are used to cool the gas. The water 332 is sent to a water treatment unit and discarded or used as feedwater in a steam system. The scrubbed gas 311 is compressed in a compressor 312 to a pressure of about 23 bara. The compressed gas 313 is then cooled 314, treated in a scrubber 316 and dehydrated 319 before it is further cooled 321 to a temperature where a portion of the CO₂ is in liquid form. This cooling is achieved by use of conventional, closed, industrial refrigeration systems (not shown in detail). The liquid CO₂ in stream 322 is separated from the gases in a low temperature (−40-−55° C.) gravity based separator 323. In the specific example the temperature is −50° C. and the pressure is 22.5 bar. The gas leaving the separator 327 is heated 328, and expanded through a valve (not shown) to obtain the operating pressure before it is mixed with the purified feed gas 103. A small portion, typically 5%, of the recycled gas is discarded in order to avoid build-up of non-combustible and non-condensable gases, typically N₂. The recycled gas typically consists of 32% H₂, 15% CO, 34% CO₂ and 18% N₂. The liquefied CO₂ 324 from the separator 323 is sent to storage 325 from which it can be transported by ship or truck, or optionally sequestered by pipeline. The liquefied CO₂ stream typically consists of more than 98% CO₂. This specific embodiment of the present invention typically has a calculated electrical efficiency of around 60% (ac/LHV).

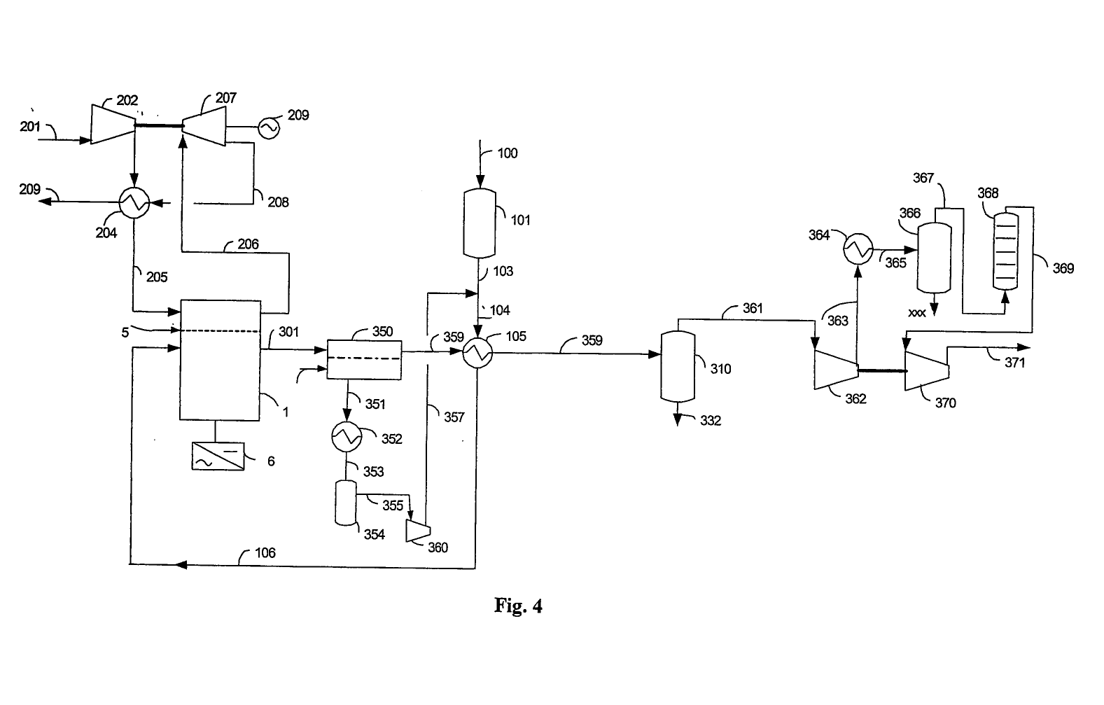

FIG. 4 is a schematic flow diagram of a specific embodiment of the present invention using a separation process based on high temperature hydrogen selective membranes in a power plant. The fuel pretreatment 101, mixing with recycle gas 357 and conversion in main SOFC 1 is similar to the example described in FIG. 2. The gas turbine unit 201-209 is also described above. In the present example the anode exhaust stream 301 enters a hydrogen selective membrane unit 350 on the feed side at 6.7 bara. The temperature is dependent on the membrane type selected and conventional cooling may be used to achieve it. Hydrogen is transferred through the membrane with a selectivity dependent on the membrane type. In the specific example the membrane is operating at a temperature of 600° C. The hydrogen rich permeate gas typically contains 50% H₂′. Typically, the pressure on the permeate side is close to ambient and a sweep gas 359 (preferably steam) is used to increase the driving force. The hydrogen rich permeate gas 351 is cooled in a heat exchanger 352 and water is removed by a condenser or scrubber 354, before the scrubbed gas 355 is compressed 360 to the operating pressure in a multistage, inter cooled compressor and mixed with the clean fuel 103. The retentate gas 358 consists of CO₂, H₂O, small amounts of H₂, CO and N₂ and is heat exchanged in 105 before water is removed by a condenser or scrubber 310. Additional coolers not shown are used to cool the gas. The scrubbed, CO₂-rich gas 361 is compressed 362, cooled 364, scrubbed 366 and dehydrated 368 before it is further compressed 370 to the desired pressure for sequestration. The CO₂-rich gas produced in this system typically has a composition of 96% CO₂, 2% H₂, 1% CO and 1% N₂. The specific embodiment of the present invention typically has a calculated electrical efficiency of around 60% (ac/LHV).

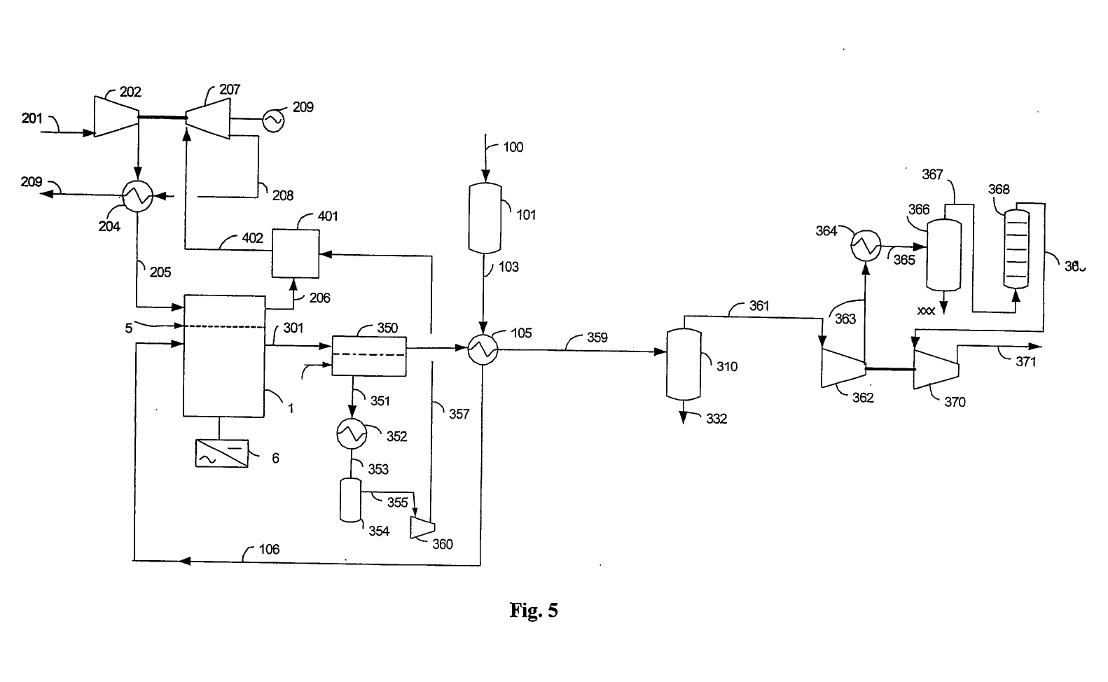

FIG. 5 is a schematic flow diagram of a specific embodiment of the present invention using a separation process based on high temperature selective membranes in a power plant and with a specific use of the recovered hydrogen. The process is as described for FIG. 4, but with the following exception. The recovered and compressed hydrogen 357 is mixed with the oxygen depleted air 20 and combusted in combustor 401, thereby increasing the temperature of the resulting mixture of oxygen depleted air and steam 402 before entering the expander 207.

### REFERENCES

[1] “A high-efficiency SOFC hybrid power system using the Mercury 50 ATS gas turbine” Wayne L. Lundberg and Stephen E. Veyo, Siemens Westinghouse Power Generation, USA [2] http://www.fuelcelltoday.com/FuelCellToday/Industrylnformation/Industrylnformation External/IndustryInformationDisplayArticle/0,1168,318,00.html
[3] http://www.ztekcorp.com/projects.htm
[4] http://www.netl.doe.gov/scng/projects/hybrid/pubs/hyb40355.pdf
[5] http://www.netl.doe.gov/scng/projects/hybrid/pubs/hyb40455.pdf

1. A method for treatment of gas exiting the anode side (301) of a solid oxide fuel cell stack (1) fuelled with a carbon containing fuel (100) in a power producing process,
characterized in that the anode gas and cathode gas are kept separated by a seal system in the SOFC stack (4) and that the main part of the H₂ and CO in the anode exhaust (351) is separated from the CO₂ in said exhaust (301) by a separation process based on H₂ selective membranes (350).

2. A method according to claim 1,
characterized in that the anode exhaust (359) is treated such that most of the CO₂ is not emitted to the atmosphere.

3. A method according to claim 1,
characterized in that steam (361) is injected on the permeate side of the hydrogen selective membranes (350).

4. A method according to claim 1,
characterized in that the recovered H₂ (355) is fed back to the main SOFC stack (1) and used as fuel.

5. A method according to claim 1,
characterized in the recovered H₂ (355) is used to heat the oxygen depleted air (206) entering the expander (207).

6. A method according to claim 1,
characterized in that the recovered H₂ (355) is used to heat the air entering the SOFC stack (205).

7. A method according to claim 1,
characterized in that the recovered H₂ (355) is exported as a sales product.

8. A method according to claim 1,
characterised in that recovered H₂ (355) is fed to the desulphurisation unit (101) to provide necessary hydrogen for hydrodesulphurisation.

9. A method for treatment of gas exiting the anode side (301) of a solid oxide fuel cell stack (1) fuelled with a carbon containing fuel (100) in a power producing process,
characterised in that the anode gas and cathode gas are kept separated by a seal system in the SOFC stack (4), that the main part of the H₂ and CO in the anode exhaust (301) is separated from the CO₂ in said exhaust by a separation process based on compressing (312), drying (319) and cooling (321) to a pressure and temperature where most of the CO₂ is in liquid form (322) and subsequently is separated from the H₂ and CO in a conventional gravity based separation process (323).

10. A method according to claim 9,
characterised in that the anode exhaust (301) is treated such that most of the CO₂ is not emitted to the atmosphere.

11. A method according to claim 9,
characterised in that the recovered H₂ an CO (329) is fed back to the main SOFC stack (1) and used as fuel

12. A method according to claim 9,
characterised in that the recovered H₂ an CO (329) is removed in order to avoid build-up of gases which are non-condensable and non-combustible.

13. A method according to claim 9,
characterised in that the recovered H₂ an CO (329) is fed to the desulphurisation unit (101) to provide the necessary hydrogen for hydrodesulphurisation.
